(19) United States
(12) Patent Application Publication
(10) Pub. No.: US 2008/0170158 A1
(43) Pub. Date: Jul. 17, 2008

(54) APPARATUS FOR AND METHOD OF PROCESSING DIGITAL IMAGE

(75) Inventors: Yon-sook Jung, Gyeonggi-do (KR); Bo-gun Park, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/747,263

(22) Filed: May 11, 2007

(30) Foreign Application Priority Data
Jan. 12, 2007 (KR) 10-2007-0003976

(51) Int. Cl. H04N 9/74

(52) U.S. Cl. 348/581; 348/E09.055

(57) ABSTRACT

An apparatus for and method of processing a digital image are provided. The apparatus for processing a digital image includes: a detection unit which detects the direction or a magnitude of an edge of an input image signal; and an edge enhancement unit which determines the degree of enhancing the edge based on the detected direction or the detected magnitude of the edge, and enhances the edge of the input image signal according to the determined degree of enhancement.

### CROSS-REFERENCE TO RELATED PATENT APPLICATIONS

This application claims the benefit of Korean Patent Application No. 10-2007-0003976, filed on Jan. 12, 2007 in the Korean Intellectual Property Office, the disclosure of which is incorporated herein in its entirety by reference.

### BACKGROUND OF THE INVENTION

1. Field of the Invention

Apparatuses and methods consistent with the present invention relate to processing a digital image.

2. Description of the Related Art

In the case of a digital camera for a mobile phone and a low price digital camera with a small number of pixels, because of the small size of an image sensor, a lens, or the like, and the function of an image processing integrated circuit (IC) is simplified in order to reduce cost, photographed images are often not clear. In particular, the boundary of an object is blurred sometimes. In order to solve this problem, an image processing method of enhancing an edge is used. With this method, the boundary of an object is enhanced, thereby allowing a clearer image to be obtained.

Also, the size of digital televisions that have been widely used recently has become increasingly larger, and related technologies have also been rapidly developed. As a higher picture quality of the digital television has been demanded, edge enhancement processing has been applied to a digital signal in order to make an original image clearer.

An edge of an image contains much information. The edge of an image means a boundary at which the position, shape, and size of an object changes. This edge exists at a position where the brightness (pixel value) of an image changes from a low value to a high value or from a high value to a low value. In addition to a general television image, edges exist in almost all places of everyday life, and the difference between the magnitudes and directions exists.

FIG. 1 is a block diagram illustrating a related art image processing apparatus for enhancing an edge according to conventional technology.

The related art image processing apparatus for enhancing an edge performs filtering of an input image signal in a filter 110. The filter 110 is mainly a high pass filter, and through the filtering, an edge area can be detected. Through addition 120, the original input image signal is added to the filtered signal, thereby generating an image signal having a clearer edge.

FIG. 2 is a reference diagram illustrating an example of the magnitude of a pixel value of an edge according to an operation of the related art image processing apparatus illustrated in FIG. 2.

The first graph illustrated in FIG. 2 shows pixel values in relation to pixels, and the horizontal axis indicates pixels, and the vertical axis indicates pixel values. An image signal is formed with numerous pixels, and a part in which differences between pixel values exist, becomes an edge area. That is, in the graph, a part having a slope is an edge area. If high pass filtering is performed by the filter 110, the signal of the edge area that is the second graph illustrated in FIG. 2 is detected.

If this detected signal is added by the original input image signal, a signal having the pixel values as the third graph illustrated in FIG. 2 is generated, in which the slope of the pixel values becomes steep, thereby enhancing the edge area.

If the edge area is enhanced, the effect of a contour part becoming clear can be obtained, but if an edge enhancement of an edge occurs in an oblique direction, a jagging artifact as illustrated in FIG. 3 can occur. This is when an oblique line in an image is not seen as one line, but as if it is a staircase. This causes degradation of picture quality and is referred to as a variety of names, including staircasing and diagonal noise. Furthermore, when the jagging artifact occurs, in order to reduce the artifact, the degree of edge enhancement in all pixels of an image is reduced, thereby decreasing the edge enhancement effect even in parts in which the jagging artifact does not occur. Accordingly, the degree of edge enhancement cannot be raised to the maximum.

### SUMMARY OF THE INVENTION

The present invention provides an apparatus for and method of processing a digital image, by which jagging artifacts can be reduced, while increasing clearness of an edge.

According to an aspect of the present invention, there is provided an apparatus for processing a digital image including: a detection unit detecting the direction or magnitude of an edge of an input image signal; and an edge enhancement unit determining the degree of enhancing the edge based on the detected direction or magnitude of the edge, and enhancing the edge of the input image signal according to the determined degree of enhancement.

The edge enhancement unit may include: a filtering unit filtering the input image signal; and a gain control unit controlling a gain by which the input image signal filtered in the filtering unit is to be multiplied, based on the detected direction or magnitude of the edge.

The detection unit may include: an edge direction detection unit detecting the direction of the edge of the input image signal; and an edge magnitude detection unit calculating the difference between pixel values of the edge of the input image signal, thereby detecting the magnitude of the edge.

The filtering unit may filter the input image signal in the vertical direction and in the horizontal direction of a pixel.

The gain control unit may include: a gain determination unit determining a gain based on the detected direction or magnitude of the edge; and a gain correction unit multiplying the image signal filtered in the filtering unit by the gain determined in the gain determination unit.

The gain control unit may further include a threshold value generation unit generating a threshold value with respect to the direction or magnitude of the edge, the threshold value being a reference for determining the gain, and the gain determination unit may determine a gain by comparing the threshold value generated in the threshold value generation unit with the detected direction or magnitude of the edge.

The threshold value generation unit may include: a direction threshold value generation unit generating one or more threshold values that are references for determining the gain, according to the direction of the edge; and a magnitude threshold value generation unit generating one or more threshold values that are references for determining the gain, according to the magnitude of the edge.

The apparatus may further include an addition unit adding the input image signal to the filtered image signal multiplied by the determined gain through the gain correction unit, thereby enhancing the edge.

According to another aspect of the present invention, there is provided a method of processing a digital image including: detecting the direction or magnitude of an edge of an input image signal; and determining the degree of enhancing the edge based on the detected direction or magnitude of the edge, and enhancing the edge of the input image signal according to the determined degree of enhancement.

The enhancing of the edge may include: filtering the input image signal in order to determine the intensity of the edge; and controlling a gain by which the filtered image signal is to be multiplied, based on the detected direction or magnitude of the edge.

In the detecting, the direction of the edge of the input image signal may be detected, or the difference between pixel values of the edge of the input image signal may be calculated, thereby detecting the magnitude of the edge.

In the filtering of the input image signal, the input image signal may be filtered in the vertical direction and in the horizontal direction of a pixel.

The controlling of the gain may include: determining a gain based on the detected direction or magnitude of the edge; and multiplying the filtered image signal by the determined gain.

Before the determining of the gain, the controlling of the gain may further include generating a threshold value with respect to the direction or magnitude of the edge, the threshold value being a reference for determining the gain, and in the determining of the gain, a gain may be determined by comparing the generated threshold value with the detected direction or magnitude of the edge.

The generating of the threshold value may include generating one or more threshold values that are references for determining the gain, according to the direction of the edge, or generating one or more threshold values that are references for determining the gain, according to the magnitude of the edge.

The method may further include adding the input image signal to the filtered image signal multiplied by the determined gain, thereby enhancing the edge.

According to another aspect of the present invention, there is provided a reception terminal which receives a signal from the outside, processes the received signal, and displays the signal, the terminal including an image processing unit detecting the direction or magnitude of an edge of an input image signal, and determining the degree of enhancing the edge based on the detected direction or magnitude of the edge, and enhancing the edge of the input image signal according to the determined degree of enhancement.

According to another aspect of the present invention, there is provided a computer readable recording medium having embodied thereon a computer program for executing a method processing a digital image, wherein the method includes: detecting the direction or magnitude of an edge of an input image signal; and determining the degree of enhancing the edge based on the detected direction or magnitude of the edge, and enhancing the edge of the input image signal according to the determined degree of enhancement.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a related art image processing apparatus for enhancing an edge;

FIG. 2 is a reference diagram illustrating an example of the magnitude of a pixel value of an edge according to an operation of the related art image processing apparatus illustrated in FIG. 2;

FIG. 3 is a reference diagram illustrating an example of a jagging artifact according to an operation of a related art image processing apparatus for enhancing an edge;

FIG. 4 is a block diagram illustrating an apparatus for processing a digital image according to an exemplary embodiment of the present invention;

FIG. 5 is a block diagram illustrating a detailed structure of the image processing apparatus illustrated in FIG. 4 according to an exemplary embodiment of the present invention;

FIG. 6 is a graph mapping the magnitude of a gain with respect to the direction of an edge according to an exemplary embodiment of the present invention;

FIG. 7A is a graph mapping the magnitude of a gain with respect to the magnitude of an edge according to an exemplary embodiment of the present invention;

FIG. 7B is a graph mapping the magnitude of a gain with respect to the magnitude of an edge according to another exemplary embodiment of the present invention;

FIG. 8 is a reference diagram illustrating the magnitude of a pixel value of an edge according to an exemplary embodiment of the present invention; and

FIG. 9 is a flowchart illustrating a method of processing a digital image according to an exemplary embodiment of the present invention.

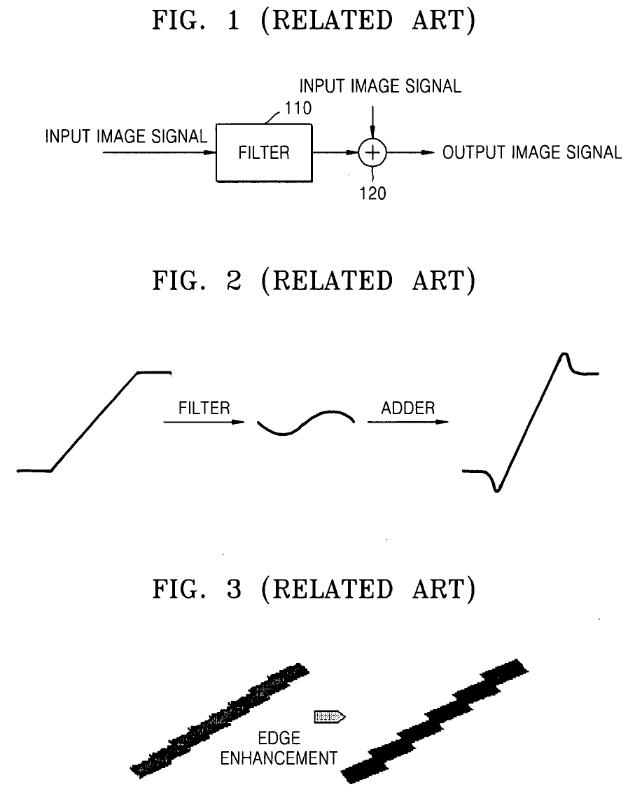

### DETAILED DESCRIPTION OF EXEMPLARY EMBODIMENTS OF THE INVENTION

The present invention will now be described more fully with reference to the accompanying drawings, in which exemplary embodiments of the invention are shown.

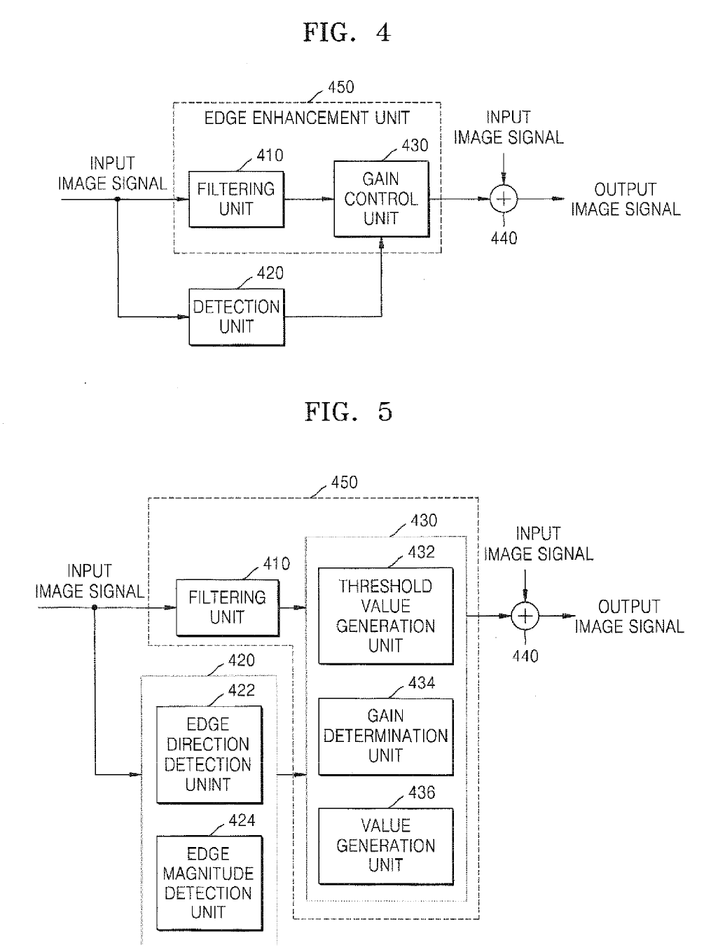

FIG. 4 is a block diagram illustrating an apparatus for processing a digital image according to an exemplary embodiment of the present invention.

Referring to FIG. 4, the digital image processing apparatus according to the current exemplary embodiment is composed of a detection unit 420, an edge enhancement unit 450, and an addition unit 440.

The detection unit 420 detects the direction or magnitude of an edge of an input image signal. The edge enhancement unit 450 determines the degree of enhancement of the edge, based on the detected direction or magnitude of the edge, and enhances the edge of the input image signal according to the determined degree of edge enhancement. The edge enhancement unit 450 includes a filtering unit 410 and a gain control unit 430.

The filtering unit 410 high pass filters the input image signal, thereby obtaining a value to be calculated in relation to each pixel. This value indicates the difference between a pixel in the vicinity of an edge area and a reference pixel value. A filter which is used in the filtering unit 410 may be a linear or non-linear filter. One pixel is filtered both in the width direction and in the length direction, and the values filtered in the width direction and in the length direction, respectively, are added up and output to the filtering unit 410.

The detection unit 420 detects the direction or magnitude of an edge of the input image signal. The detection unit 420 detects the direction, i.e., the angle, of the edge of the input image signal, and transfers information on the direction to the gain control unit 430. The transferred value may be information on all angles (0°˜360°), or some angles set by a designer of the apparatus. If an edge exists in an oblique direction, many jagging artifacts occur. Accordingly, in order to control more gain at an angle corresponding to the direction, the information on the edge is provided.

Also, the detection unit 420 calculates the difference between pixel values of adjacent pixels, thereby detecting the magnitude of the edge, and transfers the information on the magnitude to the gain control unit 430. Since the degree of occurrence of artifacts may vary according to the difference between pixel values, the information on the magnitude of the edge is provided so that the gain control unit 430 controls the gain.

The gain control unit 430 controls a gain by which the image signal filtered in the filtering unit is to be multiplied, based on the detected direction or magnitude of the edge. That is, according to the angle of the edge detected in the detection unit 420, a different gain is determined and the pixel value of the filtered image signal is multiplied by the determined gain, or according to the magnitude of the edge detected in the detection unit 420, a different gain is determined and the pixel value of the filtered image signal is multiplied by the determined gain.

In the addition unit 440, the pixel value of the original input image signal is added to the value obtained by multiplying the filtered signal by the gain in the gain control unit 430. If the value of the input image signal is added, a signal in which jagging artifacts are decreased and the edge is enhanced is output.

FIG. 5 is a block diagram illustrating a detailed structure of the image processing apparatus illustrated in FIG. 4 according to an exemplary embodiment of the present invention.

Referring to FIG. 5, the digital image processing apparatus according to the current exemplary embodiment is composed of a filtering unit 410, a detection unit 420, a gain control unit 430, and an addition unit 440. The detection unit 420 includes an edge direction unit 422 and an edge magnitude detection unit 424, and the gain control unit 430 includes a threshold value generation unit 432, a gain determination unit 434, and a gain correction unit 436.

The edge direction detection unit 422 detects the angle that indicates the direction of an edge of an input image signal. When an edge in an oblique direction appears, many jagging artifacts occur. In this way, the jagging artifacts are affected by the angle of an edge, and therefore, it is necessary to detect the angle of an edge and set a different gain according to the angle. In general, artifacts occur more strongly when the angle of an edge is in the vicinity of a 30° or 60°, rather than 45°. The edge magnitude detection unit 432 detects the magnitude of the edge. The magnitude of the edge can be obtained by calculating the difference between pixel values of adjacent pixels.

The threshold value generation unit 432 generates a threshold value for the direction of an edge, and a threshold value for the magnitude of an edge, and the threshold values become references for determining a gain. The threshold values may be set by a designer or a user from the outside. The threshold generated by an external input may be a boundary of a scope of the angle of an edge having a gain corresponding to a predetermined slope, or may be a boundary of a scope of the magnitude of an edge having a gain corresponding to a predetermined magnitude.

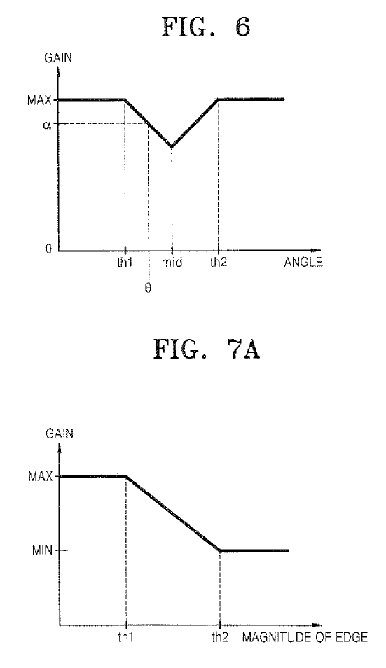

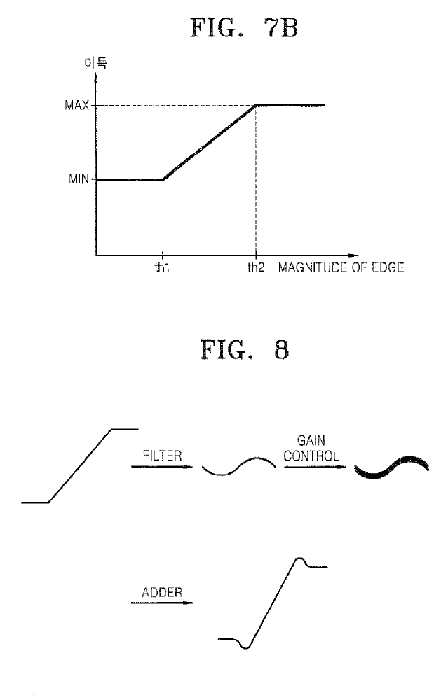

The gain determination unit 434 determines a gain, based on the direction of the edge detected in the edge direction detection unit 422 or on the magnitude of the edge detected in the edge magnitude detection unit 424. That is, the gain is determined by comparing the threshold value generated in the threshold value generation unit 432 with the detected direction or magnitude of the edge. The magnitude of the gain may be fixed as a mapping graph with reference to the threshold value, and an example of this will be explained later with reference to FIGS. 6 and 7.

The gain correction unit 436 multiplies the image signal filtered in the filtering unit 410 by the gain determined in the gain determination unit 434. Instead of applying an identical gain irrespective of the direction or magnitude of the edge, the pixels of an edge having an angle or magnitude at which many artifacts occur are multiplied by a relatively small gain, thereby decreasing the jagging artifact and at the same time achieving an edge enhancement effect. The output of the gain correction unit 436 is added to the original input image signal in the addition unit 440, thereby generating a final output image signal.

FIG. 6 is a graph mapping the magnitude of a gain with respect to the direction of an edge according to an exemplary embodiment of the present invention.

Referring to FIG. 6, with reference to threshold values ‘th1’, ‘mid’, and ‘th2’ generated in the threshold value generation unit 432, the magnitude of a gain with respect to the angle of an edge is illustrated as a mapping graph. This mapping graph is stored in the gain determination unit 434 receiving a threshold value, and therefore a gain can be determined according to a detected angle. When the angle of an edge corresponds to ‘mid’, jagging artifacts occur most frequently, and the gain in this case may have a minimum value. When the angle of the edge is equal to or less than ‘th1’, or equal to or greater than ‘th2’, the gains are identically MAX. In this case, the difference between artifacts is little, and thus user thresholds are set to ‘th1’ and ‘th2’. When an edge has an angle of θ, the gain determination unit 434 determines α that is the Y-axis of the graph as the gain. The mapping graph illustrated in FIG. 6 is just an example, and a mapping graph with respect to the angle of an edge can be drawn in a variety of shapes, and the number of threshold values may be less or more.

FIG. 7A is a graph mapping the magnitude of a gain with respect to the magnitude of an edge according to an exemplary embodiment of the present invention.

Referring to FIG. 7A, when jagging artifacts increases with the increasing magnitude of an edge, the magnitude of the gain decreases with the increasing magnitude of a threshold value in the range between the threshold values ‘th1’ and ‘th2’. When the magnitude of an edge is less than the threshold value ‘th1’, the gains are identically MAX, and when the magnitude of an edge is greater than the threshold value ‘th2’, the gains are identically MIN. The threshold values are generated in the threshold value generation unit 432, by receiving an input from a designer or user, and the magnitudes of the gain, including MAX and MIN, are determined in the gain determination unit 434, and are stored as the mapping graph illustrated in FIG. 7A.

FIG. 7B is a graph mapping the magnitude of a gain with respect to the magnitude of an edge according to another exemplary embodiment of the present invention.

When jagging artifacts increases with the increasing magnitude of an edge, the magnitude of a threshold may increase with the increasing magnitude of the edge in the range between the threshold values ‘th1’ and ‘th2’. A graph of a gain with respect to the magnitude of an edge may appear in a variety of shapes in addition to those illustrated in FIGS. 7A and 7B.

FIG. 8 is a reference diagram illustrating the magnitude of a pixel value of an edge according to an exemplary embodiment of the present invention.

The first graph of FIG. 8 is the same as that of the input image illustrated in FIG. 2, and the horizontal axis indicates a pixel, while the vertical axis indicates a pixel value. Since a part in which the difference between pixel values is big is an edge area, the slope part in the graph is an edge area. If the filtering unit 410 filters the input image signal, the slope part in the second graph is detected. This value indicates the difference between a pixel in the vicinity of the edge area and a reference pixel value.

The detection unit 420 detects the direction or magnitude of the edge, and according to the detected direction or magnitude, the gain control unit 430 determines a gain and multiplies the pixel value of the second graph by the gain creating the third graph is obtained. The shape of the pixel value multiplied by the gain can be expressed in a variety of ways according to the angle or magnitude of the edge. If the pixel value of the original input image is added in the addition unit 440, an output image signal as the fourth graph can be obtained. It can be seen that a shoot part decreases in the fourth graph compared to the graph according to the movement of the conventional apparatus illustrated in FIG. 2. Also, compared to the input image signal that is shown as the first graph of FIG. 8, the slope is steep, and the effect of enhancing the edge can also be maintained.

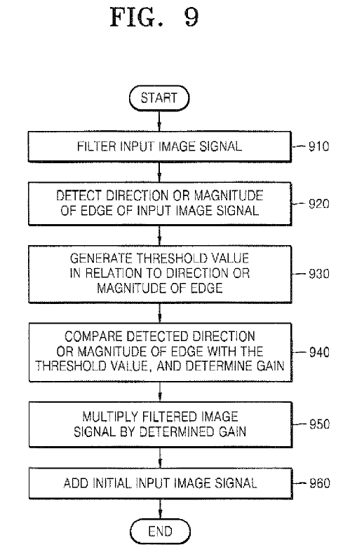

FIG. 9 is a flowchart illustrating a method of processing a digital image according to an exemplary embodiment of the present invention.

In operation 910, an input image signal is filtered. By high pass filtering the input image signal, a value which will be calculated in relation to each pixel is obtained. A filter which is used for the filtering may be linear or nonlinear.

In operation 920, the direction or magnitude of an edge in the input image signal is detected. Since the degree of occurrence of a jagging artifact varies with respect to the direction or magnitude of an edge, a different gain with respect to the direction or magnitude of the edge is applied, thereby reducing the artifacts.

In operation 930, a threshold value for the direction or magnitude of the edge is generated.

The threshold value may be set by a designer or user from the outside, and there is no limitation in the number of threshold values.

The threshold value generated by receiving an input from the outside may be a boundary of a scope of the angle of an edge having a gain corresponding to a predetermined slope, or may be a boundary of a scope of the magnitude of an edge having a gain corresponding to a predetermined magnitude.

In operation 940, the direction or magnitude of the edge detected in operation 920 is compared with the threshold value generated in operation 930, thereby determining a gain.

The gain is a value by which the filtered image signal is to be multiplied, and the magnitude of the gain may be fixed as a mapping graph with reference to a threshold value.

In operation 950, the filtered image signal is multiplied by the gain determined in operation 940, and in operation 960, the original input image signal is added to the result of the multiplication, thereby generating an output image signal in which the edge is enhanced.

According to the present invention as described above, a digital image processing apparatus and method capable of reducing jagging artifacts in an image are provided. Also, an image in which clearness of an edge is enhanced can be obtained.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for processing a digital image, the apparatus comprising:
a detection unit which detects a direction or a magnitude of an edge of an input image signal; and
an edge enhancement unit which determines a degree of enhancing the edge based on the detected direction or the detected magnitude of the edge, and enhancing the edge of the input image signal according to the determined degree of enhancement.

2. The apparatus of claim 1, wherein the edge enhancement unit comprises:
a filtering unit which filters the input image signal; and
a gain control unit which controls a gain by which the input image signal filtered in the filtering unit is to be multiplied, based on the detected direction or the detected magnitude of the edge.

3. The apparatus of claim 2, wherein the detection unit comprises:
an edge direction detection unit which detects the direction of the edge of the input image signal; and
an edge magnitude detection unit calculating a difference between pixel values of the edge of the input image signal, to detect the magnitude of the edge.

4. The apparatus of claim 3, wherein the filtering unit filters the input image signal in a vertical direction and in a horizontal direction of a pixel.

5. The apparatus of claim 3, wherein the gain control unit comprises:
a gain determination unit which determines the gain based on the detected direction or the detected magnitude of the edge; and
a gain correction unit which multiples the image signal filtered by the filtering unit by the gain determined by the gain determination unit.

6. The apparatus of claim 5, wherein the gain control unit further comprises a threshold value generation unit which generates a threshold value with respect to the direction or the magnitude of the edge, the threshold value being a reference for determining the gain, and
the gain determination unit determines a gain by comparing the threshold value generated in the threshold value generation unit with the detected direction or the detected magnitude of the edge.

7. The apparatus of claim 6, wherein the threshold value generation unit comprises:
a direction threshold value generation unit which generates at least one direction threshold value that is a reference for determining the gain, according to the direction of the edge; and
a magnitude threshold value generation unit which generates at least one magnitude threshold value that is a reference for determining the gain, according to the magnitude of the edge.

8. The apparatus of claim 5, further comprising an addition unit which adds the input image signal to the filtered image signal multiplied by the determined gain through the gain correction unit to enhance the edge.

9. A method of processing a digital image, the method comprising:
detecting a direction or a magnitude of an edge of an input image signal; determining a degree of enhancing the edge based on the detected direction or the detected magnitude of the edge; and
enhancing the edge of the input image signal according to the determined degree of enhancement.

10. The method of claim 9, wherein the enhancing of the edge comprises:
filtering the input image signal in order to determine an intensity of the edge; and
controlling a gain by which the filtered image signal is to be multiplied, based on the detected direction or the detected magnitude of the edge.

11. The method of claim 10, wherein in the detecting, the direction of the edge of the input image signal is detected, or a difference between pixel values of the edge of the input image signal is calculated, to detect the magnitude of the edge.

12. The method of claim 11, wherein in the filtering of the input image signal, the input image signal is filtered in a vertical direction and in a horizontal direction of a pixel.

13. The method of claim 11, wherein the controlling of the gain comprises:
determining the gain based on the detected direction or the detected magnitude of the edge; and
multiplying the filtered image signal by the determined gain.

14. The method of claim 13, wherein before the determining of the gain, the controlling of the gain further comprises generating a threshold value with respect to the direction or the magnitude of the edge, the threshold value being a reference for determining the gain, and
in the determining of the gain, a gain is determined by comparing the generated threshold value with the detected direction or the detected magnitude of the edge.

15. The method of claim 14, wherein the generating of the threshold value comprises generating at least one threshold value that is a reference for determining the gain, according to the direction of the edge, or generating at least one threshold value that is references for determining the gain, according to the magnitude of the edge.

16. The method of claim 13, further comprising adding the input image signal to the filtered image signal multiplied by the determined gain, to enhance the edge.

17. A reception terminal which receives a signal from the outside, processes the received signal, and displays the signal, the terminal comprising an image processing unit which detects a direction or a magnitude of an edge of an input image signal, determines a degree of enhancing the edge based on the detected direction or the detected magnitude of the edge, and enhances the edge of the input image signal according to the determined degree of enhancement.

18. A computer readable recording medium having embodied thereon a computer program for executing a method processing a digital image, wherein the method comprises:
detecting a direction or a magnitude of an edge of an input image signal; and
determining a degree of enhancing the edge based on the detected direction or the detected magnitude of the edge; and
enhancing the edge of the input image signal according to the determined degree of enhancement.
